(19) United States
(12) Patent Application Publication
(10) Pub. No.: US 2025/0080387 A1
(43) Pub. Date: Mar. 6, 2025

(54) METHODS AND APPARATUS OF RESOURCE MAPPING FOR DMRS PORTS

(71) Applicant: LENOVO (BEIJING) LIMITED, Beijing (CN)

(72) Inventors: Yi Zhang, Beijing (CN); Wei Ling, Beijing (CN); Chenxi Zhu, Fairfax, VA (US); Bingchao Liu, Beijing (CN); Lingling Xiao, Beijing (CN)

(21) Appl. No.: 18/726,601

(22) PCT Filed: Jan. 7, 2022
(86) PCT No.: PCT/CN2022/070762

§ 371 Date: Jul. 3, 2024

(51) Int. Cl. H04L 27/26; H04L 5/00

(52) U.S. Cl. CPC H04L 27/2613; H04L 5/0016

(57) ABSTRACT

Methods and apparatus of resource mapping for DMRS ports are disclosed. The method includes: receiving, by a receiver, a Demodulation Reference Signal (DMRS) configuration with a plurality of DMRS ports, the plurality of DMRS ports comprising a first port group with a first set of DMRS ports and a second port group with a second set of DMRS ports; determining, by a processor, a DMRS resource comprising a first part of the DMRS resource for the first port group and a second part of the DMRS resource for the second port group; and receiving, by the receiver, a DMRS mapped to the first part and the second part of the DMRS resource.

### FIELD

The subject matter disclosed herein relates generally to wireless communication and more particularly relates to, but not limited to, methods and apparatus of resource mapping for DMRS ports.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Downlink Control Channel (PDCCH), Physical Downlink Shared Channel (PDSCH), Code-Division Multiplexing (CDM), Control Resource Set (CORESET), Cyclic redundancy check (CRC), Downlink Control Information (DCI), Demodulation Reference Signal (DMRS, or DM-RS), Frequency Division Multiple Access (FDMA), Index/Identifier (ID), Information Element (IE), Modulation Coding Scheme (MCS), Multiple Input Multiple Output (MIMO), Multi-User MIMO (MU-MIMO), Orthogonal Cover Code (OCC), Physical Resource Block (PRB), Resource Element (RE), Radio Network Temporary Identifier (RNTI), Time-Division Multiplexing (TDM), Transmission and Reception Point (TRP), Cell Radio Network Temporary Identifier (C-RNTI), Configured Scheduling RNTI (CS-RNTI), Frequency Range 1 (FR1), Frequency Range 2 (FR2), System Information RNTI (SI-RNTI), Technical Specification (TS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

It is important to identify and specify necessary enhancements for both downlink and uplink MIMO for facilitating the use of large antenna array, not only for FR1 but also for FR2 to fulfil the request for evolution of NR deployments in Release 18.

### SUMMARY

Methods and apparatus of resource mapping for DMRS ports are disclosed.

According to a first aspect, there is provided a method, including: receiving, by a receiver, a Demodulation Reference Signal (DMRS) configuration with a plurality of DMRS ports, the plurality of DMRS ports comprising a first port group with a first set of DMRS ports and a second port group with a second set of DMRS ports; determining, by a processor, a DMRS resource comprising a first part of the DMRS resource for the first port group and a second part of the DMRS resource for the second port group; and receiving, by the receiver, a DMRS mapped to the first part and the second part of the DMRS resource.

According to a second aspect, there is provided a method, including: transmitting, by a transmitter, a Demodulation Reference Signal (DMRS) configuration with a plurality of DMRS ports, the plurality of DMRS ports comprising a first port group with a first set of DMRS ports and a second port group with a second set of DMRS ports; determining, by a processor, a DMRS resource comprising a first part of the DMRS resource for the first port group and a second part of the DMRS resource for the second port group; and transmitting, by the transmitter, a DMRS mapped to the first part and the second part of the DMRS resource.

According to a third aspect, there is provided an apparatus, including: a receiver that receives a Demodulation Reference Signal (DMRS) configuration with a plurality of DMRS ports, the plurality of DMRS ports comprising a first port group with a first set of DMRS ports and a second port group with a second set of DMRS ports; and a processor that determines a DMRS resource comprising a first part of the DMRS resource for the first port group and a second part of the DMRS resource for the second port group; wherein the receiver further receives a DMRS mapped to the first part and the second part of the DMRS resource.

According to a fourth aspect, there is provided an apparatus, including: a transmitter that transmits a Demodulation Reference Signal (DMRS) configuration with a plurality of DMRS ports, the plurality of DMRS ports comprising a first port group with a first set of DMRS ports and a second port group with a second set of DMRS ports; and a processor that determines a DMRS resource comprising a first part of the DMRS resource for the first port group and a second part of the DMRS resource for the second port group; and wherein the transmitter further transmits a DMRS mapped to the first part and the second part of the DMRS resource.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIGS. 4A and 4B are schematic diagrams illustrating examples of resource mapping for additional DMRS ports based on legacy DMRS pattern in accordance with some implementations of the present disclosure;

FIGS. 5A and 5B are schematic diagrams illustrating examples of OCC based CDM schemes for Type 1 and Type 2 DMRS in accordance with some implementations of the present disclosure;

FIGS. 6A and 6B are schematic diagrams illustrating examples of REs grouping for different antenna port t groups in accordance with some implementations of the present disclosure;

FIG. 7 is a flow chart illustrating steps of resource mapping for DMRS ports for reception of a DMRS by UE or gNB in accordance with some implementations of the present disclosure; and

FIG. 8 is a flow chart illustrating steps of resource mapping for DMRS ports for transmission of a DMRS by UE or gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

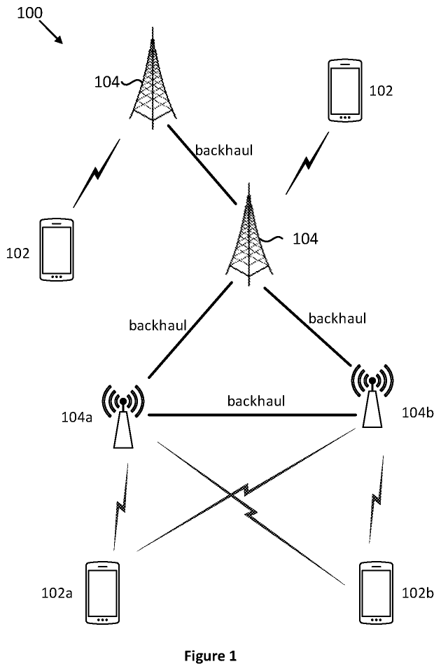

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

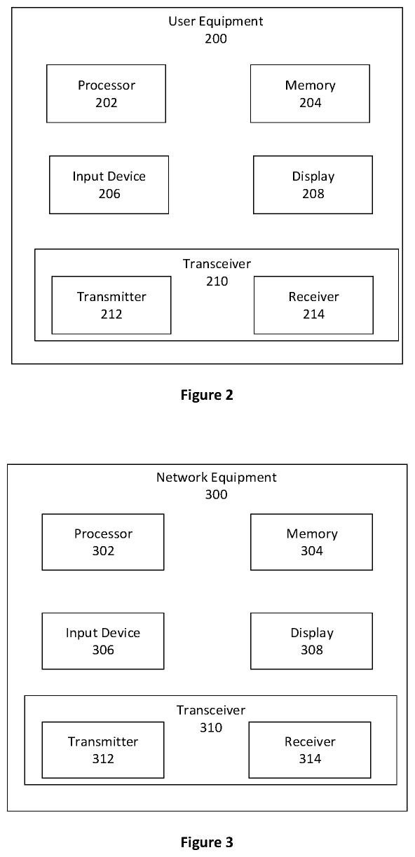

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

With the increasing need for multiplexing capacity of downlink and uplink demodulation reference signal (DMRS) from various use cases, there is a need for increasing the number of orthogonal ports for DMRS. Based on the current specification, only 8 orthogonal DMRS ports and 12 orthogonal DMRS ports are supported for type 1 and type 2 DMRS, respectively. According to the requirement for increasing DMRS ports, e.g. maximum 24 DMRS ports, the resource mapping schemes should be defined.

Two DMRS configuration types have been introduced in Release 15, which are referred to as DMRS Type 1 and DMRS Type 2. Both of them can support a single-symbol and a double-symbol configuration, where two antenna ports are orthogonalized on the same resource elements using a length-2 OCC sequence and eight antenna ports are orthogonalized using a length-2 OCC sequence for the double symbol DMRS on top of using frequency domain length-2 OCC sequence and 2 CDM groups. Specific pattern is designed as shown in the following Table 1 and Table 2 for type1 and type 2 DMRS, respectively. In the time domain, the front-load DMRS is used in the DMRS pattern. And, a set of additional DMRS symbols can be optionally introduced, which are distributed inside the scheduled data channel duration. The detailed pattern is designed as shown in Table 3 and Table 4 for single symbol (i.e., maxLength=1) and double symbol (i.e., maxLength=2) DMRS, respectively. The mapping relation between PDSCH DMRS time index and antenna ports is designed as shown in Table 5. The detailed information on resource mapping for DMRS is described in TS 28.211 as follows.

The UE shall assume the PDSCH DMRS being mapped to physical resources according to configuration type 1 or configuration type 2 as given by the higher-layer parameter dmrs-Type.

The UE shall assume the sequence r(m) is scaled by a factor β_{PDSCH}^{DMRS} to conform

with the transmission power specified in [6, TS 38.214] and mapped to resource elements (k, l)_{p,μ} according to

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

where w_{f}(k′), wₜ(l′), and Δ are given by Tables 1 and 2 and the following conditions are fulfilled:
the resource elements are within the common resource blocks allocated for PDSCH transmission
   The reference point for k is
subcarrier 0 of the lowest-numbered resource block in CORESET 0 if the corresponding PDCCH is associated with CORESET 0 and Type0-PDCCH common search space and is addressed to SI-RNTI;
otherwise, subcarrier 0 in common resource block 0
   The reference point for l and the position l₀ of the first DMRS symbol depends on the mapping type:
for PDSCH mapping type A:
l is defined relative to the start of the slot
l₀=3 if the higher-layer parameter dmrs-TypeA-Position is equal to ‘pos3’ and l₀=2 otherwise
for PDSCH mapping type B:
l is defined relative to the start of the scheduled PDSCH resources
l₀=0
   The position(s) of the DMRS symbols is given by l̅ and duration l_{d} where
for PDSCH mapping type A, l_{d} is the duration between the first OFDM symbol of the slot and the last OFDM symbol of the scheduled PDSCH resources in the slot
for PDSCH mapping type B, l_{d} is the duration of the scheduled PDSCH resources;
   and according to Tables 3 and 4.

TABLE 1
Parameters for PDSCH DMRS configuration type 1.

| | | |
|---|---|---|
| CDM group | w_{f} (k′) | wₜ (l′) |

| p | λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
Parameters for PDSCH DMRS configuration type 2.

| | | |
|---|---|---|
| CDM group | w_{f} (k′) | wₜ (l′) |

| p | λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

TABLE 3
PDSCH DMRS positions l̅ for single-symbol DMRS.

| | DMRS positions l̅ | | | | | | | |
|---|---|---|---|---|---|---|---|---|
| | PDSCH mapping type A | | | | PDSCH mapping type B | | | |
| l_{d} in | dmrs-AdditionalPosition | | | | dmrs-AdditionalPosition | | | |
| symbols | pos0 | pos1 | pos2 | pos3 | pos0 | pos1 | pos2 | pos3 |
| 2 | — | — | — | — | l₀ | l₀ | l₀ | l₀ |
| 3 | l₀ | l₀ | l₀ | l₀ | l₀− | l₀− | l₀ | l₀ |
| 4 | l₀ | l₀ | l₀ | l₀ | l₀ | l₀ | l₀ | l₀ |
| 5 | l₀ | l₀ | l₀ | l₀ | l₀− | l₀, 4− | l₀, 4 | l₀, 4 |
| 6 | l₀ | l₀ | l₀ | l₀ | l₀ | l₀, 4 | l₀, 4 | l₀, 4 |
| 7 | l₀ | l₀ | l₀ | l₀ | l₀ | l₀, 4 | l₀, 4 | l₀, 4 |
| 8 | l₀ | l₀, 7 | l₀, 7 | l₀, 7 | l₀− | l₀, 6− | l₀, 3, 6 | l₀, 3, 6 |
| 9 | l₀ | l₀, 7 | l₀, 7 | l₀, 7 | l₀− | l₀, 7− | l₀, 4, 7 | l₀, 4, 7 |
| 10 | l₀ | l₀, 9 | l₀, 6, 9 | l₀, 6, 9 | l₀− | l₀, 7− | l₀, 4, 7 | l₀, 4, 7 |
| 11 | l₀ | l₀, 9 | l₀, 6, 9 | l₀, 6, 9 | l₀− | l₀, 8− | l₀, 4, 8 | l₀, 3, 6, 9 |
| 12 | l₀ | l₀, 9 | l₀, 6, 9 | l₀, 5, 8, 11 | l₀− | l₀, 9− | l₀, 5, 9 | l₀, 3, 6, 9 |
| 13 | l₀ | l₀, l₁ | l₀, 7, 11 | l₀, 5, 8, 11 | l₀− | l₀, 9− | l₀, 5, 9 | l₀, 3, 6, 9 |
| 14 | l₀ | l₀, l₁ | l₀, 7, 11 | l₀, 5, 8, 11 | — | — | — | — |

TABLE 4
PDSCH DMRS positions l̅ for double-symbol DMRS.

| | DMRS positions l̅ | | | | | |
|---|---|---|---|---|---|---|
| | PDSCH mapping type A | | | PDSCH mapping type B | | |
| l_{d} in | dmrs-AdditionalPosition | | | dmrs-AdditionalPosition | | |
| symbols | pos0 | pos1 | pos2 | pos0 | pos1 | pos2 |
| <4 | | | | — | — | |
| 4 | l₀ | l₀ | | — | — | |
| 5 | l₀ | l₀ | | l₀− | l₀− | |
| 6 | l₀ | l₀ | | l₀ | l₀ | |
| 7 | l₀ | l₀ | | l₀ | l₀ | |
| 8 | l₀ | l₀ | | l₀− | l₀, 5− | |
| 9 | l₀ | l₀ | | l₀− | l₀, 5− | |
| 10 | l₀ | l₀, 8 | | l₀− | l₀, 7− | |
| 11 | l₀ | l₀, 8 | | l₀− | l₀, 7− | |
| 12 | l₀ | l₀, 8 | | l₀− | l₀, 8− | |
| 13 | l₀ | l₀, 10 | | l₀− | l₀, 8− | |
| 14 | l₀ | l₀, 10 | | — | — | |

TABLE 5
PDSCH DMRS time index l′ and antenna ports p.

| Single or double | | Supported antenna ports p | |
|---|---|---|---|
| symbol DMRS | l′ | Configuration type 1 | Configuration type 2 |
| single | 0 | 1000-1003 | 1000-1005 |
| double | 0, 1 | 1000-1007 | 1000-1011 |

One or two scrambling IDs can be used for DMRS sequence. When two scrambling IDs are configured, dynamic signalling may be used to indicate which one is used for DMRS transmission. The detailed information is specified in TS 38.211 as follows.

The UE shall assume the sequence r(n) is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1. The pseudo-random sequence generator shall be initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot, n_{s,f}^{μ} is the slot number within a frame, and
N_{ID}⁰, N_{ID}¹∈{0,1, . . . , 65535} are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI
N_{ID}⁰∈{0,1, . . . ,65535} is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;

$${N}_{ID}^{{\overline{n}}_{SCID}^{\overline{λ}}} = {N}_{ID}^{cell}$$

otherwise;
n̅_{SCID}^{λ̅} and λ̅ are given by
if the higher-layer parameter dmrsDownlink-r16 in the DMRS-DownlinkConfig IE is provided

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group defined in clause 7.4.1.1.2.
otherwise by

n̅_{SCID}^{λ̅}=n_{SCID}

λ̅=0

The quantity n_{SCID}∈{0, 1} is given by the DMRS sequence initialization field, if present, in the DCI associated with the PDSCH transmission if DCI format 1_1 or 1_2 in [4, TS 38.212] is used, otherwise n_{SCID}=0.

In this one example, where maxLength=2, there is definition for resource mapping on DMRS ports 0-7 (e.g. ports 1000-1007 in Table 1 and Table 5) and ports 0-11 (e.g. ports 1000-1011 in Table 2 and Table 5) for type 1 and type 2 DMRS, respectively. In Release 18, more than 8 DMRS ports for Type 1 DMRS or more than 12 DMRS ports for Type 2 DMRS will be introduced to support high dimension DMRS. The maximum orthogonal DMRS port number may be 16DMRS ports for Type 1 DMRS or more than 24 DMRS ports for Type 2 DMRS.

In some other examples, where maxLength=1, resource mapping on DMRS ports 0-3 (e.g. ports 1000-1003 in Table 1 and Table 5) and ports 0-5 (e.g. ports 1000-1005 in Table 2 and Table 5) for type1 and type 2 DMRS is defined. In Release 18, more than 4 DMRS ports for Type 1 DMRS or more than 6 DMRS ports for Type 2 DMRS will be introduced to support high dimension DMRS. The maximum orthogonal DMRS port number may be 8 DMRS ports for Type 1 DMRS or more than 12 DMRS ports for Type 2 DMRS.

DMRS pattern specified in Release 15 or Release 16 is obtained by simulation evaluation campaign, and good demodulation performance is guaranteed.

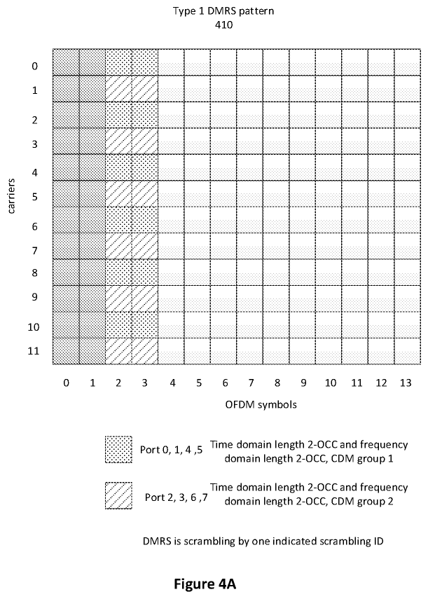

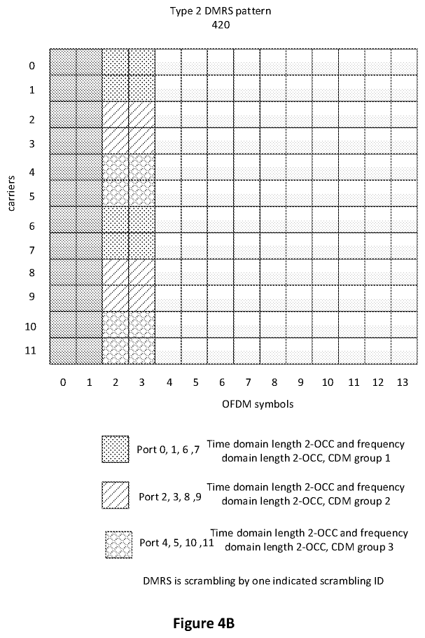

FIGS. 4A and 4B are schematic diagrams illustrating examples of resource mapping for additional DMRS ports based on legacy DMRS pattern in accordance with some implementations of the present disclosure. The two Figures illustrate DMRS patterns for DMRS ports 0-7 (i.e. DMRS port group 0) and DMRS ports 0-11 (i.e. DMRS port group 0) for type 1 and type 2 DMRS, respectively. In FIG. 4A, the Type 1 DMRS pattern 410 includes ports 0, 1, 4, 5, with time domain length 2 OCC and frequency domain length 2 OCC of CDM group 1, and ports 2, 3, 6, 7, with time domain length 2 OCC and frequency domain length 2 OCC of CDM group 2. In FIG. 4B, the Type 2 DMRS pattern 420 includes ports 0, 1, 6, 7, with time domain length 2 OCC and frequency domain length 2 OCC of CDM group 1, ports 2, 3, 8, 9, with time domain length 2 OCC and frequency domain length 2 OCC of CDM group 2, and ports 4, 5, 10, 11, with time domain length 2 OCC and frequency domain length 2 OCC of CDM group 3.

For resource mapping schemes that could support up to 24 DMRS ports, to reduce standard effort, the resource mapping scheme for Type 1 DMRS ports 0-7 and Type 2 DMRS ports 0-11 should be reused as much as possible. The following description regarding the time frequency resource, OCC sequence, scrambling sequence for additional DMRS ports 8-15 and DMRS ports 12-23 for type 1 and type 2 DMRS is provided as an example where maxlength=2. The same method and/or principle is also applicable to other examples where maxLength=1.

In order to determine resources for additional DMRS ports, e.g. DMRS ports 8-15 (i.e. DMRS port group 1) for type 1 DMRS and DMRS ports 12-23 (i.e. DMRS port group 1) for type 2 DMRS, additional DMRS resource is introduced. Thus, DMRS resource for large number of DMRS ports is composed by available DMRS resource (i.e. DMRS resource 0) and additional DMRS resource (i.e. DMRS resource 1), where additional DMRS resource is determined by legacy DMRS design but with some different parameters. DMRS for one UE is mapped into only one DMRS resource. In this way, it can support large number of DMRS ports introduced by large number of MU-MIMO users by exploiting available Release 15 DMRS resource mapping scheme as much as possible. To simplify the aggregation scheme and signaling indication for used DMRS ports, similar configuration is used for DMRS resource 0 and DMRS resource 1, which includes dmrs-Type, maxLength. Additional parameters of CDM group λ, subcarrier offset between CDM group Δ, time domain and frequency domain OCC sequence w_{f}(k′), wₜ(l′) and DMRS sequence may be or may not be the same, which depends on actual resource mapping schemes as descripted in the following paragraphs. For additional DMRS resource 1, the different DM-RS sequence or DM-RS sequence group or OCC sequence group, RE group and OFDM symbols group may be used.

### Sequence Based CDM Scheme

For the first kind of scheme, one DM-RS sequence is used for one DMRS resource corresponding to the DMRS port group. The DM-RS sequence is generated based on one initial scrambling ID from scrambling ID group. In detail, DM-RS sequence 0 is used for ports 0-7 for Type 1 DMRS and ports 0-11 for Type 2 DMRS, and DM-RS sequence 1 is used for ports 8-15 for Type 1 DMRS and ports 12-23 for Type 2 DMRS. The parameters of CDM group λ, subcarrier offset between CDM group Δ, time domain and frequency domain OCC sequence w_{f}(k′), wₜ(l′) are the same for DMRS port i (0-7 for DMRS type 1 and 0-11 for DMRS type 2) and DMRS port i+k (k=8 for DMRS type 1 and k=12 for DMRS type 2 in the case of maxlength=2; k=4 for DMRS type 1 and k-6 for DMRS type 1 in the case of maxlength=1). One example is shown in Table 6 for type 1 DMRS. In this way, the interference between different DMRS port groups can be mitigated by beamforming technology. For initial scrambling ID for DM-RS sequence, it can reuse existing configured scrambling ID by two higher-layer parameters scramblingID0 and scramblingID1. One scrambling ID can be used for sequence generation for one DMRS resource. Alternatively, two additional scrambling IDs may be used on account that 4 TRPs are targeted in Release 18 design. Two scrambling IDs (i.e. consisting of scrambling ID group) can be possibly used for one DMRS resource. The two additional scrambling IDs can be configured or fixed in specification. For example, they are specified as scramblingID0+1 and scramblingID1+1.

TABLE 6
Parameters for PDSCH DMRS configuration type 1.

| | | | | | | | DMRS resource |
|---|---|---|---|---|---|---|---|
| | | | | | | | Or DM-RS |
| | | | | | | | sequence |
| | CDM | | | | | | or DM-RS |
| | group | | w_{f} (k′) | | wₜ (l′) | | sequence |
| p | λ | Δ | k′ = 0 | k′ = 1 | l′ = 0 | l′ = 1 | group |
| 1000 | 0 | 0 | +1 | +1 | +1 | +1 | 0 |
| 1001 | 0 | 0 | +1 | −1 | +1 | +1 | 0 |
| 1002 | 1 | 1 | +1 | +1 | +1 | +1 | 0 |
| 1003 | 1 | 1 | +1 | −1 | +1 | +1 | 0 |
| 1004 | 0 | 0 | +1 | +1 | +1 | −1 | 0 |
| 1005 | 0 | 0 | +1 | −1 | +1 | −1 | 0 |
| 1006 | 1 | 1 | +1 | +1 | +1 | −1 | 0 |
| 1007 | 1 | 1 | +1 | −1 | +1 | −1 | 0 |
| 1008 | 0 | 0 | +1 | +1 | +1 | +1 | 1 |
| 1009 | 0 | 0 | +1 | −1 | +1 | +1 | 1 |
| 1010 | 1 | 1 | +1 | +1 | +1 | +1 | 1 |
| 1011 | 1 | 1 | +1 | −1 | +1 | +1 | 1 |
| 1012 | 0 | 0 | +1 | +1 | +1 | −1 | 1 |
| 1013 | 0 | 0 | +1 | −1 | +1 | −1 | 1 |
| 1014 | 1 | 1 | +1 | +1 | +1 | −1 | 1 |
| 1015 | 1 | 1 | +1 | −1 | +1 | −1 | 1 |

### OCC Based CDM Scheme

For the second kind of scheme, one OCC sequence group is used for one DMRS resource corresponding to the DMRS port group. OCC sequence group 0 is used for ports 0-7 for Type 1 DMRS and ports 0-11 for Type 2 DMRS and OCC sequence group 1 is used for ports 8-15 for Type 1 DMRS and ports 12-23 for Type 2 DMRS. The parameters of CDM group λ, subcarrier offset between CDM group Δ, time domain OCC sequence wₜ(l′) and scrambling ID are the same for DMRS port i (0-7 for DMRS type 1 and 0-11 for DMRS type 2) and DMRS port i+k (k=8 for DMRS type 1 and k=12 for DMRS type 2 in the case of maxLength=2; k=4 for DMRS type 1 and k=6 for DMRS type 1 in the case of maxLength=1). OCC sequence group 0 is determined by legacy length 2 OCC sequence with repetition and OCC sequence group 1 is determined by newly introduced length 4 OCC sequence. For example, [1 1 1 1] and [1 −1 1 −1] are used as OCC sequence in OCC sequence group 0 for DMRS resource 0 and [1 1 −1 −1] and [1 −1 −1 1] are used as additional OCC sequence in OCC sequence group 1 for DMRS resource 1. One example is shown in Table 7 for type 2 DMRS. For DMRS type 2, there are 4 REs in one symbol of a PRB for a DMRS CDM group. Length 4 OCC sequence can be easily used. However, for DMRS type 1, there are 6 REs in one symbol of a PRB for a DMRS CDM group. This gives difficulty to use length 4 OCC sequence. As a simple solution, two PRBs can be bundled together for using length 4 OCC sequence.

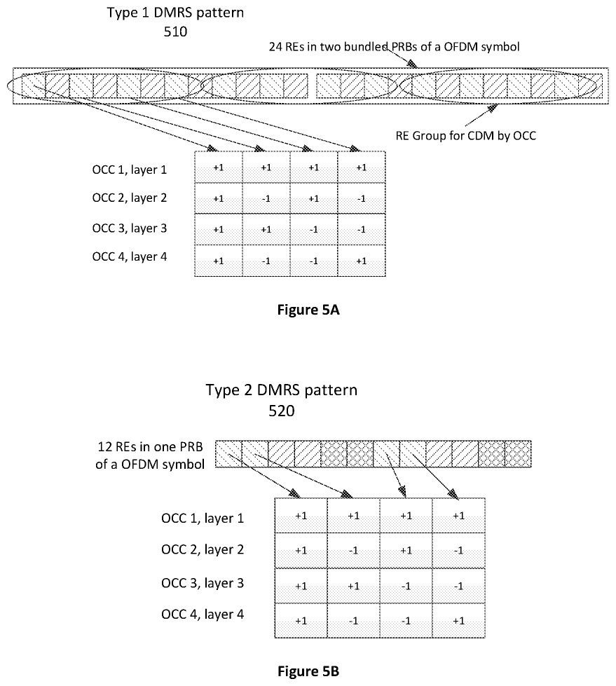

FIGS. 5A and 5B are schematic diagrams illustrating examples of OCC based CDM schemes for Type 1 and Type 2 DMRS in accordance with some implementations of the present disclosure.

As example shown in FIGS. 5A and 5B, 3 RE groups can be used for length 4 OCC sequence for DMRS REs in two bundled PRBs. The adjacent 4 REs in one CDM group is used to consist RE group for length 4 OCC sequence to guarantee channel estimation performance.

TABLE 7
Parameters for PDSCH DMRS configuration type 2.

| | | | | | | | | | DMRS |
|---|---|---|---|---|---|---|---|---|---|
| | | | | | | | | | resource |
| | CDM | | | | | | | | Or OCC |
| | group | | w_{f} (k′) | | | | wₜ (l′) | | sequence |
| p | λ | Δ | k′ = 0 | k′ = 1 | k′ = 2 | k′ = 3 | l′ = 0 | l′ = 1 | group |
| 1000 | 0 | 0 | +1 | +1 | +1 | +1 | +1 | +1 | 0 |
| 1001 | 0 | 0 | +1 | −1 | +1 | −1 | +1 | +1 | 0 |
| 1002 | 1 | 2 | +1 | +1 | +1 | +1 | +1 | +1 | 0 |
| 1003 | 1 | 2 | +1 | −1 | +1 | −1 | +1 | +1 | 0 |
| 1004 | 2 | 4 | +1 | +1 | +1 | +1 | +1 | +1 | 0 |
| 1005 | 2 | 4 | +1 | −1 | +1 | −1 | +1 | +1 | 0 |
| 1006 | 0 | 0 | +1 | +1 | +1 | +1 | +1 | −1 | 0 |
| 1007 | 0 | 0 | +1 | −1 | +1 | −1 | +1 | −1 | 0 |
| 1008 | 1 | 2 | +1 | +1 | +1 | +1 | +1 | −1 | 0 |
| 1009 | 1 | 2 | +1 | −1 | +1 | −1 | +1 | −1 | 0 |
| 1010 | 2 | 4 | +1 | +1 | +1 | +1 | +1 | −1 | 0 |
| 1011 | 2 | 4 | +1 | −1 | +1 | −1 | +1 | −1 | 0 |
| 1012 | 0 | 0 | +1 | +1 | −1 | −1 | +1 | +1 | 1 |
| 1013 | 0 | 0 | +1 | −1 | −1 | +1 | +1 | +1 | 1 |
| 1014 | 1 | 2 | +1 | +1 | −1 | −1 | +1 | +1 | 1 |
| 1015 | 1 | 2 | +1 | −1 | −1 | +1 | +1 | +1 | 1 |
| 1016 | 2 | 4 | +1 | +1 | −1 | −1 | +1 | +1 | 1 |
| 1017 | 2 | 4 | +1 | −1 | −1 | +1 | +1 | +1 | 1 |
| 1018 | 0 | 0 | +1 | +1 | −1 | −1 | +1 | −1 | 1 |
| 1019 | 0 | 0 | +1 | −1 | −1 | +1 | +1 | −1 | 1 |
| 1020 | 1 | 2 | +1 | +1 | −1 | −1 | +1 | −1 | 1 |
| 1021 | 1 | 2 | +1 | −1 | −1 | +1 | +1 | −1 | 1 |
| 1022 | 2 | 4 | +1 | +1 | −1 | −1 | +1 | −1 | 1 |
| 1023 | 2 | 4 | +1 | −1 | −1 | +1 | +1 | −1 | 1 |

### FDM Based Scheme

For the third kind of scheme, one RE group is used for one DMRS resource corresponding to the DMRS port group. RE group 0 is used for ports 0-7 for Type 1 DMRS and ports 0-11 for Type 2 DMRS and RE group 1 is used for ports 8-15 for Type 1 DMRS and ports 12-23 for Type 2 DMRS. The parameters of CDM group λ, subcarrier offset between CDM group Δ, time domain and frequency domain OCC sequence w_{f}(k′), wₜ(l′) and scrambling ID are the same for DMRS port i (0-7 for DMRS type 1 and 0-11 for DMRS type 2 in the case of maxLength=2; k=4 for DMRS type 1 and k=6 for DMRS type 1 in the case of maxLength=1) and DMRS port i+k (k=8 for DMRS type 1 and k=12 for DMRS type 2). Similar Table 6 can be used for this scheme, where DM-RS resource for different DM-RS port group in the last column can be denoted by corresponding RE group. However, different RE groups are used for DMRS resource 0 and DMRS resource 1. On account of 6 REs in a group for Type 1 DMRS, it is difficult to divide them into 2 DMRS port groups in case of length 2 OCC sequence used for each DMRS port group. Thus, 2 PRBs are bundled to make resource mapping for two DMRS port groups.

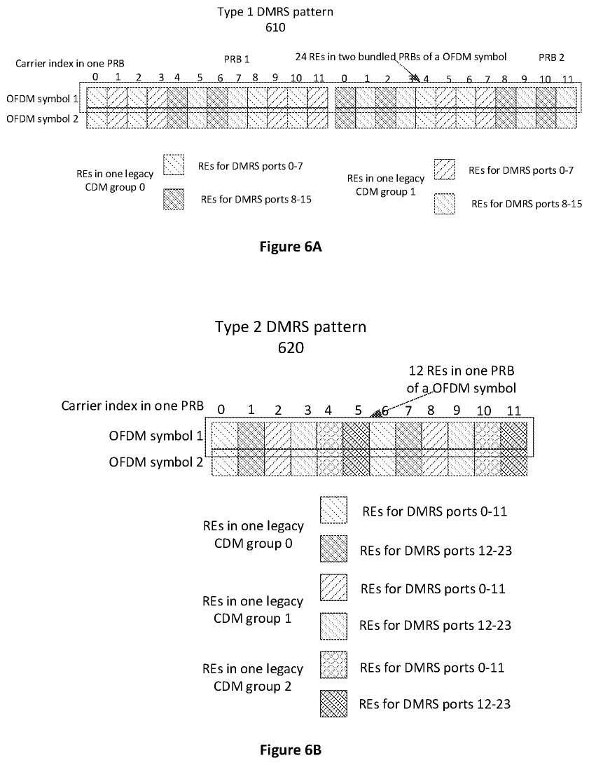

FIGS. 6A and 6B are schematic diagrams illustrating examples of REs grouping for different antenna port groups in accordance with some implementations of the present disclosure. As shown in FIGS. 6A and 6B, RE group 0 and RE group 0 are used for DMRS port group 0 and DMRS port group 1, respectively.

For type 1 DMRS pattern 610, RE group 0 of CDM group 0 consists of REs from carrier {0 2 8 10} in PRB 0 and carrier {4 6} in PRB 1. And, length 2 OCC sequence is used for carrier {0 2} in PRB 0, carrier {8 10} in PRB 0, carrier {4 6} in PRB 1, respectively; RE group 1 of CDM group 0 consists of REs from carrier {4 6} in PRB 0 and carrier {0 2 8 10} in PRB 1. And, length 2 OCC sequence is used for carrier {0 2} in PRB 1, carrier {8 10} in PRB 1, carrier {4 6} in PRB 2, respectively.

For type 2 DMRS pattern 620, RE group 0 of CDM group 0 consists of REs from carrier {0 6} in a PRB. And, length 2 OCC sequence is used for carrier {0 6} in a PRB; RE group 1 of CDM group 0 consists of REs from carrier {1 7} in a PRB. And, length 2 OCC sequence is used for carrier {1 7} in a PRB. As another example, for type 2 DMRS pattern 620, RE group 0 of CDM group 0 consists of REs from carrier {0,1} in a PRB. And, length 2 OCC sequence is used for carrier {0 1} in a PRB; RE group 1 of CDM group 0 consists of REs from carrier {6, 7} in a PRB. And, length 2 OCC sequence is used for carrier {6, 7} in a PRB. Here, REs for one DMRS port group are distributed evenly in a PRB and this is used to achieve better demodulation performance.

### TDM Based Scheme

For the fourth kind of scheme, one OFDM symbol group is used for one DMRS resource corresponding to the DMRS port group. OFDM symbol group 0 is used for ports 0-7 for Type 1 DMRS and ports 0-11 for Type 2 DMRS and OFDM symbol group 1 is used for ports 8-15 for Type 1 DMRS and ports 12-23 for Type 2 DMRS. The parameters of CDM group λ, subcarrier offset between CDM group Δ, time domain and frequency domain OCC sequence w_{f}(k′), wₜ(l′) and scrambling ID are the same for DMRS port i (0-7 for DMRS type 1 and 0-11 for DMRS type 2) and DMRS port i+k (k=8 for DMRS type 1 and k=12 for DMRS type 2 in the case of maxLength=2; k=4 for DMRS type 1 and k=6 for DMRS type 1 in the case of maxLength=1). Alternatively, length 4 OCC sequence may be used for 4 OFDM symbols and wₜ(l′) can change to length 4 OCC sequence. Similar Table 6 can be used for this scheme. However, different OFDM symbol groups are used for DMRS resource 0 and DMRS resource 1 for the last column.

As an example shown in Table 8 for DM-RS with configuration of maxLength=2, two additional symbols {x, x+1} are introduced for DMRS resource 1. OFDM symbol group 0, i.e. symbol {0, 1}, and OFDM symbol group 1, i.e. {x, x+1} are associated with DMRS port group 0 and DMRS port group 1, respectively. As a simple solution, x may be specified as 2. It is reasonable if length 4 OCC sequence is introduced in time domain.

TABLE 8
PDSCH DMRS time index l′ and antenna ports p.

| | | Supported antenna ports p | |
|---|---|---|---|
| DMRS symbol | | Configuration | Configuration |
| number | l′ | type 1 | type 2 |
| single | 0 | 1000-1003 | 1000-1005 |
| double | 0, 1 | 1000-1007 | 1000-1011 |
| four | 0, 1, x, x + 1 | 1000-1015 | 1000-1023 |

As another alternative, x can be defined as the second OFDM symbol index for double-symbol DMRS on account that 4 available OFDM symbols in this double-symbol DMRS pattern can be reused. As an example, it may be one of the numerical values in the column “pos1” as shown in Table 4, which is determined according to PDSCH duration and DMRS type. If these legacy values are used, it can guarantee DMRS performance since they are defined based on massive evaluation.

As another example for DM-RS with configuration of maxLength=1, one additional symbol {x} is introduced for DMRS resource 1. OFDM symbol group 0, i.e. symbol {0}, and OFDM symbol group 1, i.e. {x} are associated with DMRS port group 0 and DMRS port group 1, respectively. As a simple solution, x can be specified as 1. It is reasonable if length 4 OCC sequence is introduced in time domain.

As another alternative, x can be defined as the second OFDM symbol index for single-symbol DMRS on account that 2 available OFDM symbols in the single-symbol DMRS pattern can be reused. As an example, it may be one of the numerical values in the column “pos1” as shown in Table 3, which is determined according to PDSCH duration and DMRS type. If these legacy values are used, it can guarantee DMRS performance since they are defined based on massive evaluation.

The proposed DM-RS resource mapping scheme may be applicable for both downlink DM-RS and uplink DM-RS.

On account of limited number of OFDM symbols in one slot, DMRS OFDM symbols from different groups can come from adjacent/different slots from two slots if PDSCH can be scheduled into two slots together.

It should be understood that the different schemes as described may be dynamically or semi-statically switched on account of different application scenarios, channel condition, scheduling requirement.

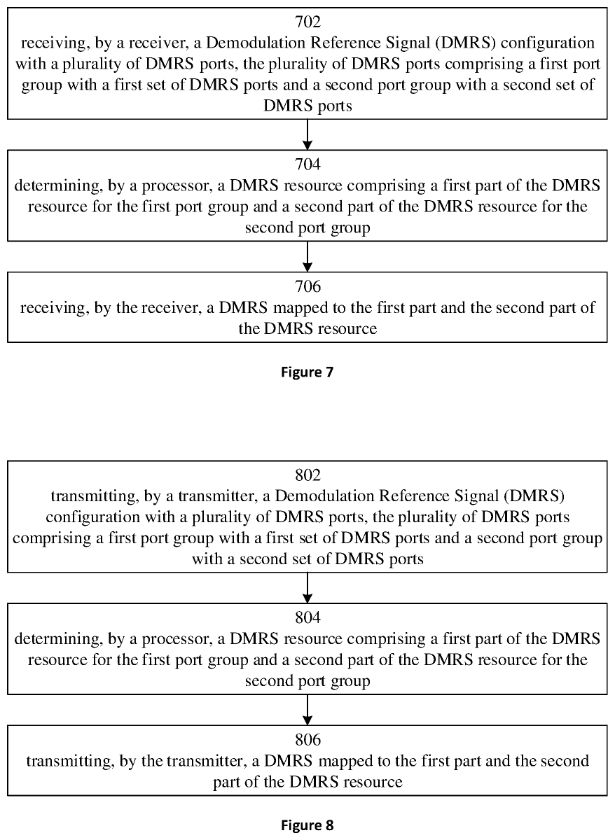

FIG. 7 is a flow chart illustrating steps of resource mapping for DMRS ports for reception of a DMRS by UE 200 or gNB 300 in accordance with some implementations of the present disclosure.

At step 702, the receiver 214 or 314 receives a Demodulation Reference Signal (DMRS) configuration with a plurality of DMRS ports, the plurality of DMRS ports comprising a first port group with a first set of DMRS ports and a second port group with a second set of DMRS ports.

At step 704, the processor 202 or 302 determines a DMRS resource comprising a first part of the DMRS resource for the first port group and a second part of the DMRS resource for the second port group.

At step 706, the receiver 214 or 314 receives a DMRS mapped to the first part and the second part of the DMRS resource.

FIG. 8 is a flow chart illustrating steps of resource mapping for DMRS ports for transmission of a DMRS by UE 200 or gNB 300 in accordance with some implementations of the present disclosure.

At step 802, the transmitter 212 or 312 transmits a Demodulation Reference Signal (DMRS) configuration with a plurality of DMRS ports, the plurality of DMRS ports comprising a first port group with a first set of DMRS ports and a second port group with a second set of DMRS ports.

At step 804, the processor 202 or 302 determines a DMRS resource comprising a first part of the DMRS resource for the first port group and a second part of the DMRS resource for the second port group.

At step 806, the transmitter 212 or 312 transmits a DMRS mapped to the first part and the second part of the DMRS resource.

In one aspect, some items as examples of the disclosure concerning a method of reception of a DMRS by UE or gNB may be summarized as follows:
1. A method, comprising:
receiving, by a receiver, a Demodulation Reference Signal (DMRS) configuration with a plurality of DMRS ports, the plurality of DMRS ports comprising a first port group with a first set of DMRS ports and a second port group with a second set of DMRS ports;
determining, by a processor, a DMRS resource comprising a first part of the DMRS resource for the first port group and a second part of the DMRS resource for the second port group; and
receiving, by the receiver, a DMRS mapped to the first part and the second part of the DMRS resource.
2. The method of item 1, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.
3. The method of item 1, wherein each DMRS port of the second set in the second port group is distinguished from a corresponding DMRS port of the first set in the first port group by a distinguishing parameter.
4. The method of item 3, wherein the distinguishing parameter is scrambling ID group indicating different DMRS sequences.
5. The method of item 4, and each DMRS port of the second set in the second port group and its corresponding DMRS port of the first set in the first port group are configured with identical Code-Division Multiplexing (CDM) group λ, subcarrier offset between CDM group Δ, time domain Orthogonal Cover Code (OCC) sequence wₜ(l′), and frequency domain OCC sequence w_{f}(k′).
6. The method of item 4, wherein each scrambling ID in a second scrambling ID group for the second port group is associated with a corresponding scrambling ID in a first scrambling ID group for the first port group, or is configured separately.
7. The method of item 3, wherein the distinguishing parameter is OCC sequence group indicating different frequency domain OCC sequences w_{f}(k′).
8. The method of item 7, wherein each DMRS port of the second set in the second port group and its corresponding DMRS port of the first set in the first port group are configured with identical CDM group λ, subcarrier offset between CDM group Δ, time domain OCC sequence wₜ(l′), and identical scrambling ID.
9. The method of item 7, wherein the OCC sequence group for the second port group consists of length 4 OCC sequences {[+1 +1 −1 −1], [+1 −1 −1 +1]}.
10. The method of item 7, wherein the OCC sequence group for the first port group consists of length 4 OCC sequences {[+1 +1 +1 +1], [+1 −1 +1 −1]}.
11. The method of item 7, wherein, for Type 1 DMRS, two Physical Resource Blocks (PRBs) are bundled for application of OCC sequences in the OCC sequence group.
12. The method of item 3, wherein the distinguishing parameter is Resource Element (RE) group indicating a different group of REs.
13. The method of item 12, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
14. The method of item 12, wherein, for Type 1 DMRS, a first RE group and a second RE group are selected in pairs from a CDM group of a first PRB and a second PRB in a PRB bundle, respectively, in a non-overlapping manner in frequency domain.
15. The method of item 12, wherein RE group 0 of CDM group 0 consists REs from carrier {0 2 8 10} in the first bundled PRB and carrier {4 6} in the second bundled PRB; and RE group 1 of CDM group 0 consists of REs from carrier {4 6} in the first bundled PRB and carrier {0 2 8 10} in the second bundled PRB.
16. The method of item 12, wherein, for Type 2 DMRS, a first RE group and a second RE group are selected in pairs from a CDM group of a PRB in a non-overlapping manner in frequency domain.
17. The method of item 12, wherein RE group 0 of CDM group 0 consists REs from carrier {0 6} or {0, 1} in a PRB; and RE group 1 of CDM group 0 consists of REs from carrier {1 7} or {6 7} in a PRB.
18. The method of item 3, wherein the distinguishing parameter is Orthogonal Frequency Division Multiplexing (OFDM) symbol group indicating different group of OFDM symbols.
19. The method of item 18, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
20. The method of item 18, wherein OFDM symbols in an OFDM symbol group of the second port group are symbols {2, 3} or symbols {x, x+1}, where x is derivable from an OFDM symbol index defined for a double-symbol DMRS.
21. The method of item 1, wherein parameters, dmrs-Type and maxLength, for the first part and the second part of the DMRS resource are configured identically.

In another aspect, some items as examples of the disclosure concerning a method of transmission of a DMRS by UE or gNB may be summarized as follows:
22. A method, comprising:
transmitting, by a transmitter, a Demodulation Reference Signal (DMRS) configuration with a plurality of DMRS ports, the plurality of DMRS ports comprising a first port group with a first set of DMRS ports and a second port group with a second set of DMRS ports;
determining, by a processor, a DMRS resource comprising a first part of the DMRS resource for the first port group and a second part of the DMRS resource for the second port group; and
transmitting, by the transmitter, a DMRS mapped to the first part and the second part of the DMRS resource.
23. The method of item 22, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.
24. The method of item 22, wherein each DMRS port of the second set in the second port group is distinguished from a corresponding DMRS port of the first set in the first port group by a distinguishing parameter.
25. The method of item 24, wherein the distinguishing parameter is scrambling ID group indicating different DMRS sequences.
26. The method of item 25, and each DMRS port of the second set in the second

port group and its corresponding DMRS port of the first set in the first port group are configured with identical Code-Division Multiplexing (CDM) group λ, subcarrier offset between CDM group Δ, time domain Orthogonal Cover Code (OCC) sequence wₜ(l′), and frequency domain OCC sequence w_{f}(k′).
27. The method of item 25, wherein each scrambling ID in a second scrambling ID group for the second port group is associated with a corresponding scrambling ID in a first scrambling ID group for the first port group, or is configured separately.
28. The method of item 24, wherein the distinguishing parameter is OCC sequence group indicating different frequency domain OCC sequences w_{f}(k′).
29. The method of item 28, wherein each DMRS port of the second set in the second port group and its corresponding DMRS port of the first set in the first port group are configured with identical CDM group λ, subcarrier offset between CDM group Δ, time domain OCC sequence wₜ(l′), and identical scrambling ID.
30. The method of item 28, wherein the OCC sequence group for the second port group consists of length 4 OCC sequences {[+1 +1 −1 −1], [+1 −1 −1 +1]}.
31. The method of item 28, wherein the OCC sequence group for the first port group consists of length 4 OCC sequences {[+1 +1 +1 +1], [+1 −1 +1 −1]}.
32. The method of item 28, wherein, for Type 1 DMRS, two Physical Resource Blocks (PRBs) are bundled for application of OCC sequences in the OCC sequence group.
33. The method of item 24, wherein the distinguishing parameter is Resource Element (RE) group indicating a different group of REs.
34. The method of item 33, wherein each DMRS port of the second set in the second port group and its corresponding DMRS port of the first set in the first port group are configured with identical CDM group 2, subcarrier offset between CDM group Δ, time domain OCC sequence wₜ(l′), scrambling ID, and frequency domain OCC sequence w_{f}(k′).
35. The method of item 33, wherein, for Type 1 DMRS, a first RE group and a second RE group are selected in pairs from a CDM group of a first PRB and a second PRB in a PRB bundle, respectively, in a non-overlapping manner in frequency domain.
36. The method of item 33, wherein RE group 0 of CDM group 0 consists REs from carrier {0 2 8 10} in the first bundled PRB and carrier {4 6} in the second bundled PRB; and RE group 1 of CDM group 0 consists of REs from carrier {4 6} in the first bundled PRB and carrier {0 2 8 10} in the second bundled PRB.
37. The method of item 33, wherein, for Type 2 DMRS, a first RE group and a second RE group are selected in pairs from a CDM group of a PRB in a non-overlapping manner in frequency domain.
38. The method of item 33, wherein RE group 0 of CDM group 0 consists REs from carrier {0 6} or {0, 1} in a PRB; and RE group 1 of CDM group 0 consists of REs from carrier {1 7} or {6 7} in a PRB.
39. The method of item 24, wherein the distinguishing parameter is Orthogonal Frequency Division Multiplexing (OFDM) symbol group indicating different group of OFDM symbols.
40. The method of item 39, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
41. The method of item 39, wherein OFDM symbols in an OFDM symbol group of the second port group are symbols {2, 3} or symbols {x, x+1}, where x is derivable from an OFDM symbol index defined for a double-symbol DMRS.
42. The method of item 22, wherein parameters, dmrs-Type and maxLength, for the first part and the second part of the DMRS resource are configured identically.

In a further aspect, some items as examples of the disclosure concerning UE or gNB for reception of a DMRS may be summarized as follows:
43. An apparatus, comprising:
a receiver that receives a Demodulation Reference Signal (DMRS) configuration with a plurality of DMRS ports, the plurality of DMRS ports comprising a first port group with a first set of DMRS ports and a second port group with a second set of DMRS ports; and
a processor that determines a DMRS resource comprising a first part of the DMRS resource for the first port group and a second part of the DMRS resource for the second port group;
wherein the receiver further receives a DMRS mapped to the first part and the second part of the DMRS resource.
44. The apparatus of item 43, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.
45. The apparatus of item 43, wherein each DMRS port of the second set in the second port group is distinguished from a corresponding DMRS port of the first set in the first port group by a distinguishing parameter.
46. The apparatus of item 45, wherein the distinguishing parameter is scrambling ID group indicating different DMRS sequences.
47. The apparatus of item 46, and each DMRS port of the second set in the second port group and its corresponding DMRS port of the first set in the first port group are configured with identical Code-Division Multiplexing (CDM) group λ, subcarrier offset between CDM group Δ, time domain Orthogonal Cover Code (OCC) sequence wₜ(l′), and frequency domain OCC sequence w_{f}(k′).
48. The apparatus of item 46, wherein each scrambling ID in a second scrambling ID group for the second port group is associated with a corresponding scrambling ID in a first scrambling ID group for the first port group, or is configured separately.
49. The apparatus of item 45, wherein the distinguishing parameter is OCC sequence group indicating different frequency domain OCC sequences w_{f}(k′).
50. The apparatus of item 49, wherein each DMRS port of the second set in the second port group and its corresponding DMRS port of the first set in the first port group are configured with identical CDM group λ, subcarrier offset between CDM group Δ, time domain OCC sequence wₜ(l′), and identical scrambling ID.
51. The apparatus of item 49, wherein the OCC sequence group for the second port group consists of length 4 OCC sequences {[+1 +1 −1 −1], [+1 −1 −1 +1]}.
52. The apparatus of item 49, wherein the OCC sequence group for the first port group consists of length 4 OCC sequences {[+1 +1 +1 +1], [+1 −1 +1 −1]}.
53. The apparatus of item 49, wherein, for Type 1 DMRS, two Physical Resource Blocks (PRBs) are bundled for application of OCC sequences in the OCC sequence group.
54. The apparatus of item 45, wherein the distinguishing parameter is Resource Element (RE) group indicating a different group of REs.
55. The apparatus of item 54, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
56. The apparatus of item 54, wherein, for Type 1 DMRS, a first RE group and a second RE group are selected in pairs from a CDM group of a first PRB and a second PRB in a PRB bundle, respectively, in a non-overlapping manner in frequency domain.
57. The apparatus of item 54, wherein RE group 0 of CDM group 0 consists REs from carrier {0 2 8 10} in the first bundled PRB and carrier {4 6} in the second bundled PRB; and RE group 1 of CDM group 0 consists of REs from carrier {4 6} in the first bundled PRB and carrier {0 2 8 10} in the second bundled PRB.
58. The apparatus of item 54, wherein, for Type 2 DMRS, a first RE group and a second RE group are selected in pairs from a CDM group of a PRB in a non-overlapping manner in frequency domain.
59. The apparatus of item 54, wherein RE group 0 of CDM group 0 consists REs from carrier {0 6} or {0, 1} in a PRB; and RE group 1 of CDM group 0 consists of REs from carrier {1 7} or {6 7} in a PRB.
60. The apparatus of item 45, wherein the distinguishing parameter is Orthogonal Frequency Division Multiplexing (OFDM) symbol group indicating different group of OFDM symbols.
61. The apparatus of item 60, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
62. The apparatus of item 60, wherein OFDM symbols in an OFDM symbol group of the second port group are symbols {2, 3} or symbols {x, x+1}, where x is derivable from an OFDM symbol index defined for a double-symbol DMRS.
63. The apparatus of item 43, wherein parameters, dmrs-Type and maxLength, for the first part and the second part of the DMRS resource are configured identically.

In a yet further aspect, some items as examples of the disclosure concerning UE or gNB for transmission of a DMRS may be summarized as follows:
64. An apparatus, comprising:
a transmitter that transmits a Demodulation Reference Signal (DMRS) configuration with a plurality of DMRS ports, the plurality of DMRS ports comprising a first port group with a first set of DMRS ports and a second port group with a second set of DMRS ports; and
a processor that determines a DMRS resource comprising a first part of the DMRS resource for the first port group and a second part of the DMRS resource for the second port group; and
wherein the transmitter further transmits a DMRS mapped to the first part and the second part of the DMRS resource.
65. The apparatus of item 64, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.
66. The apparatus of item 64, wherein each DMRS port of the second set in the second port group is distinguished from a corresponding DMRS port of the first set in the first port group by a distinguishing parameter.
67. The apparatus of item 66, wherein the distinguishing parameter is scrambling ID group indicating different DMRS sequences.
68. The apparatus of item 67, and each DMRS port of the second set in the second port group and its corresponding DMRS port of the first set in the first port group are configured with identical Code-Division Multiplexing (CDM) group λ, subcarrier offset between CDM group Δ, time domain Orthogonal Cover Code (OCC) sequence wₜ(l′), and frequency domain OCC sequence w_{f}(k′).
69. The apparatus of item 67, wherein each scrambling ID in a second scrambling ID group for the second port group is associated with a corresponding scrambling ID in a first scrambling ID group for the first port group, or is configured separately.
70. The apparatus of item 66, wherein the distinguishing parameter is OCC sequence group indicating different frequency domain OCC sequences w_{f}(k′).
71. The apparatus of item 70, wherein each DMRS port of the second set in the second port group and its corresponding DMRS port of the first set in the first port group are configured with identical CDM group λ, subcarrier offset between CDM group Δ, time domain OCC sequence wₜ(l′), and identical scrambling ID.
72. The apparatus of item 70, wherein the OCC sequence group for the second port group consists of length 4 OCC sequences {[+1 +1 −1 −1], [+1 −1 −1 +1]}.
73. The apparatus of item 70, wherein the OCC sequence group for the first port group consists of length 4 OCC sequences {[+1 +1 +1 +1], [+1 −1 +1 −1]}.
74. The apparatus of item 70, wherein, for Type 1 DMRS, two Physical Resource Blocks (PRBs) are bundled for application of OCC sequences in the OCC sequence group.
75. The apparatus of item 66, wherein the distinguishing parameter is Resource Element (RE) group indicating a different group of REs.
76. The apparatus of item 75, wherein each DMRS port of the second set in the second port group and its corresponding DMRS port of the first set in the first port group are configured with identical CDM group λ, subcarrier offset between CDM group Δ, time domain OCC sequence wₜ(l′), scrambling ID, and frequency domain OCC sequence w_{f}(k′).
77. The apparatus of item 75, wherein, for Type 1 DMRS, a first RE group and a second RE group are selected in pairs from a CDM group of a first PRB and a second PRB in a PRB bundle, respectively, in a non-overlapping manner in frequency domain.
78. The apparatus of item 75, wherein RE group 0 of CDM group 0 consists REs from carrier {0 2 8 10} in the first bundled PRB and carrier {4 6} in the second bundled PRB; and RE group 1 of CDM group 0 consists of REs from carrier {4 6} in the first bundled PRB and carrier {0 2 8 10} in the second bundled PRB.
79. The apparatus of item 75, wherein, for Type 2 DMRS, a first RE group and a second RE group are selected in pairs from a CDM group of a PRB in a non-overlapping manner in frequency domain.
80. The apparatus of item 75, wherein RE group 0 of CDM group 0 consists REs from carrier {0 6} or {0, 1} in a PRB; and RE group 1 of CDM group 0 consists of REs from carrier {1 7} or {6 7} in a PRB.
81. The apparatus of item 66, wherein the distinguishing parameter is Orthogonal Frequency Division Multiplexing (OFDM) symbol group indicating different group of OFDM symbols.
82. The apparatus of item 81, wherein each DMRS port of the second set in the second port group and its corresponding DMRS port of the first set in the first port group are configured with identical CDM group λ, subcarrier offset between CDM group 4, time domain OCC sequence wₜ(l′), scrambling ID, and frequency domain OCC sequence w_{f}(k′).
83. The apparatus of item 81, wherein OFDM symbols in an OFDM symbol group of the second port group are symbols {2, 3} or symbols {x, x+1}, where x is derivable from an OFDM symbol index defined for a double-symbol DMRS.
84. The apparatus of item 64, wherein parameters, dmrs-Type and maxLength, for the first part and the second part of the DMRS resource are configured identically.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A method performed by a user equipment (UE), the method comprising:
receiving a Demodulation Reference Signal (DMRS) configuration with a plurality of DMRS ports, the plurality of DMRS ports comprising a first port group with a first set of DMRS ports and a second port group with a second set of DMRS ports;
determining a DMRS resource comprising a first part of the DMRS resource for the first port group and a second part of the DMRS resource for the second port group; and
receiving a DMRS mapped to the first part and the second part of the DMRS resource.

2. The method of claim 1, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.

3. The method of claim 1, wherein each DMRS port of the second set in the second port group is distinguished from a corresponding DMRS port of the first set in the first port group by a distinguishing parameter.

4. The method of claim 3, wherein the distinguishing parameter is scrambling ID group indicating different DMRS sequences; and each scrambling ID in a second scrambling ID group for the second port group is associated with a corresponding scrambling ID in a first scrambling ID group for the first port group, or is configured separately.

5. The method of claim 3, wherein the distinguishing parameter is OCC sequence group indicating different frequency domain OCC sequences w f (k′).

6. The method of claim 5, wherein each DMRS port of the second set in the second port group and its corresponding DMRS port of the first set in the first port group are configured with identical CDM group λ, subcarrier offset between CDM group Δ, time domain OCC sequence w t (l′), and identical scrambling ID.

7. The method of claim 5, wherein the OCC sequence group for the second port group consists of length 4 OCC sequences {[+1 +1 −1 −1], [+1 −1 −1 +1]}.

8. The method of claim 5, wherein, for Type 1 DMRS, two Physical Resource Blocks (PRBs) are bundled for application of OCC sequences in the OCC sequence group.

9. The method of claim 3, wherein the distinguishing parameter is Resource Element (RE) group indicating a different group of REs.

10. The method of claim 9, wherein each DMRS port of the second set in the second port group and its corresponding DMRS port of the first set in the first port group are configured with identical CDM group λ, subcarrier offset between CDM group Δ, time domain OCC sequence w t (l′), scrambling ID, and frequency domain OCC sequence w f (k′).

11. The method of claim 9, wherein, for Type 1 DMRS, a first RE group and a second RE group are selected in pairs from a CDM group of a first PRB and a second PRB in a PRB bundle, respectively, in a non-overlapping manner in frequency domain; or for Type 2 DMRS, a first RE group and a second RE group are selected in pairs from a CDM group of a PRB in a non-overlapping manner in frequency domain.

12. The method of claim 9, wherein RE group 0 of CDM group 0 consists REs from carrier {0 2 8 10} in a first bundled physical resource block (PRB) and carrier {4 6} in a second bundled PRB; and RE group 1 of CDM group 0 consists of REs from carrier {4 6} in the first bundled PRB and carrier {0 2 8 10} in the second bundled PRB.

13. The method of claim 9, wherein RE group 0 of CDM group 0 consists REs from carrier {0 6} or {0, 1} in a PRB; and RE group 1 of CDM group 0 consists of REs from carrier {1 7} or {6 7} in a PRB.

14. The method of claim 3, wherein the distinguishing parameter is Orthogonal Frequency Division Multiplexing (OFDM) symbol group indicating different group of OFDM symbols; and OFDM symbols in an OFDM symbol group of the second port group are symbols {2, 3} or symbols {x, x+1}, where x is derivable from an OFDM symbol index defined for a double-symbol DMRS.

15. The method of claim 1, wherein parameters, dmrs-Type and maxLength, for the first part and the second part of the DMRS resource are configured identically.

16. A user equipment (UE), comprising:
at least one memory; and
at least one processor coupled with the at least one memory and configured to cause the UE to:
receive a Demodulation Reference Signal (DMRS) configuration with a plurality of DMRS ports, the plurality of DMRS ports comprising a first port group with a first set of DMRS ports and a second port group with a second set of DMRS ports;
determine a DMRS resource comprising a first part of the DMRS resource for the first port group and a second part of the DMRS resource for the second port group; and
receive a DMRS mapped to the first part and the second part of the DMRS resource.

17. The UE of claim 16, wherein the plurality of DMRS ports comprises more than 4 DMRS or more than 8 DMRS ports for Type 1 DMRS configured with maxLength=1 or maxLength=2 respectively, or comprises more than 6 DMRS or more than 12 DMRS ports for Type 2 DMRS configured with maxLength=1 or maxLength=2 respectively.

18. The UE of claim 16, wherein each DMRS port of the second set in the second port group is distinguished from a corresponding DMRS port of the first set in the first port group by a distinguishing parameter.

19. The UE of claim 18, wherein the distinguishing parameter is scrambling ID group indicating different DMRS sequences; and each scrambling ID in a second scrambling ID group for the second port group is associated with a corresponding scrambling ID in a first scrambling ID group for the first port group, or is configured separately.

20. A processor for wireless communication, comprising:
at least one controller coupled with at least one memory and configured to cause the processor to:
receive a Demodulation Reference Signal (DMRS) configuration with a plurality of DMRS ports, the plurality of DMRS ports comprising a first port group with a first set of DMRS ports and a second port group with a second set of DMRS ports;
determine a DMRS resource comprising a first part of the DMRS resource for the first port group and a second part of the DMRS resource for the second port group; and
receive a DMRS mapped to the first part and the second part of the DMRS resource.
